(19) United States
(12) Patent Application Publication
(10) Pub. No.: US 2010/0158160 A1
(43) Pub. Date: Jun. 24, 2010

(54) EXTRACTING INFORMATION FROM POSITIONING PILOT CHANNEL SYMBOLS IN FORWARD LINK ONLY SYSTEM

(75) Inventors: KRISHNA K. MUKKAVILLI, San Diego, CA (US); Raghuraman Krishnamoorthi, San Diego, CA (US); Ashok Mantravadi, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/643,664

(22) Filed: Dec. 21, 2009

Related U.S. Application Data
(60) Provisional application No. 61/140,849, filed on Dec. 24, 2008.
(60) Provisional application No. 61/158,397, filed on Mar. 9, 2009.

(51) Int. Cl. H04L 27/06

(52) U.S. Cl. 375/340

(57) ABSTRACT

Methods, systems, and apparatus, including computer programs encoded on computer readable storage media, for extracting transmitter identification information from the Positioning Pilot Channel (PPC) of a MediaFLO superframe. One of a wide area differentiator (WID) value and a local area differentiator (LID) value associated with the transmitter is determined based on signaling in a first interlace of a symbol received via the PPC. A time domain channel estimate is computed for the PPC based on signaling in a plurality of interlaces of the symbol and also based on the one of the WID and LID values. The time domain channel estimate is used to obtain a frequency domain channel estimate for a second interlace of the symbol that carries the transmitter identification information, and the frequency domain channel estimate is used to determine the transmitter identification information.

### CLAIM OF PRIORITY UNDER 35 U.S.C. §119

The present application for patent claims priority to Provisional Application No. 61/140,849 filed Dec. 24, 2008, and to Provisional Application No. 61/158,397 filed Mar. 9, 2009, both assigned to the assignee hereof and both hereby expressly incorporated by reference herein.

### TECHNICAL FIELD

The present disclosure relates generally to wireless communications and, more particularly, to utilization of Positioning Pilot Channel (PPC) symbols transmitted in a Media Forward Link Only (also referred to as MediaFLO or FLO) communication system.

### BACKGROUND

The Positioning Pilot Channel (PPC) is a new channel added to FLO AIS rev A (TIA-1099-A) standard, which standard is incorporated herein by reference. An important functionality of PPC symbols is to provide transmitter identification related information such as receiver power, signal to interference plus noise ratio (SINR), channel estimate and propagation delay information from each network transmitter. If the transmitter identification information is successfully detected in the associated PPC symbol at the receiver, the detected information may be used, for example, to perform network operation and performance diagnostics, or to support applications that determine the geographic location of the receiver, such as a mobile unit receiver.

It is therefore desirable to provide for extracting information from PPC symbols.

### SUMMARY

This specification describes technologies relating to extracting information from positioning pilot channel symbols in forward link only systems. One innovative aspect of the subject matter described in this specification can be implemented in methods that include the actions of extracting transmitter identification information from the PPC. One of a wide area differentiator (WID) value and a local area differentiator (LID) value associated with the transmitter is determined based on signaling in a first interlace of a symbol received via the PPC. A time domain channel estimate is computed for the PPC based on signaling in a plurality of interlaces of the symbol and also based on the one of the WID and LID values. The time domain channel estimate is used to obtain a frequency domain channel estimate for a second interlace of the symbol that carries the transmitter identification information, and the frequency domain channel estimate is used to determine the transmitter identification information. Other implementations of this aspect include corresponding systems, apparatus, and computer programs, configured to perform the actions of the methods, encoded on computer readable storage media.

These and other implementations can each optionally include one or more of the following features. A plurality of possible values of the one of the WID value and the LID value can be used to descramble frequency domain samples obtained from the first interlace and thereby produce a plurality of descrambled results. A plurality of time domain channel estimates can be produced based respectively on the descrambling results. Respective corresponding energy measures can be computed for the time domain channel estimates and one of the WID value and the LID value can be determined based on the energy measures. An energy threshold can be applied to tap energies of each of the time domain channel estimates. The energy threshold can be produced based on a further energy measure associated with the first interlace. One of the WID value and the LID value can be used to descramble frequency domain samples obtained from the plurality of interlaces. The other of the WID value and the LID value can be determined based on signaling associated with a third interlace of the symbol and also based on the one of the WID value and the LID value. Computing the time domain channel estimate can be computed based on the other of the WID value and the LID value. The plurality of interlaces can be a subset of a total amount of interlaces of the symbol. The time domain channel estimate can include: zero-padding the time domain channel estimate to produce a zero-padded time domain channel estimate; applying first stage Fast Fourier Transform (FFT) processing to the zero-padded time domain channel estimate to produce time domain samples associated with the symbol; and obtaining the frequency domain channel estimate from a subset of the time domain samples associated with the second interlace.

Details of one or more implementations of the subject matter described in this specification are set forth in the accompanying drawings and the description below. Other features, aspects, and advantages will become apparent from the description, the drawings, and the claims.

### BRIEF DESCRIPTION OF THE DRAWINGS

Various aspects of a wireless communications system are illustrated by way of example, and not by way of limitation, in the accompanying drawings, wherein:

FIG. 1 illustrates superframe structure in FLO;

FIG. 2 illustrates interlaces used for active and inactive PPC transmissions in FLO;

FIGS. 3-6 illustrate operations according to exemplary embodiments of the present work;

FIG. 7 diagrammatically illustrates an apparatus capable of performing operations of FIGS. 3 and 4 according to exemplary embodiments of the present work;

FIG. 8 diagrammatically illustrates an apparatus capable of performing operations of FIGS. 3, 5 and 6 according to exemplary embodiments of the present work;

FIG. 9 diagrammatically illustrates memory management for WID/LID detection according to exemplary embodiments of the present work;

FIG. 10 diagrammatically illustrates memory management for processing interlaces 0, 2, 4 and 6 of FIG. 2 according to exemplary embodiments of the present work;

FIG. 11 diagrammatically illustrates a communication system according to exemplary embodiments of the present work; and

FIG. 12 diagrammatically illustrates a de-interleaving operation implemented by the present work.

Like reference numbers and designations in the various drawings indicate like elements.

### DETAILED DESCRIPTION

The detailed description set forth below in connection with the appended drawings is intended as a description of various embodiments of the present work and is not intended to represent the only embodiments in which the present work may be practiced. The detailed description includes specific details for the purpose of providing a thorough understanding of the present work. However, it will be apparent to those skilled in the art that the present work may be practiced without these specific details.

In some instances, well known structures and components are shown in block diagram form in order to avoid obscuring the concepts of the present work. The word “exemplary” is used herein to mean “serving as an example, instance, or illustration.” Any embodiment described herein as “exemplary” is not necessarily to be construed as preferred or advantageous over other embodiments.

In the following detailed description, various concepts will be described in the context of a FLO technology. While these concepts may be well suited for this application, those skilled in the art will readily appreciate that these concepts are likewise applicable to other technology. Accordingly, any reference to FLO technology is intended only to illustrate these concepts, with the understanding that such concepts have a wide range of applicability.

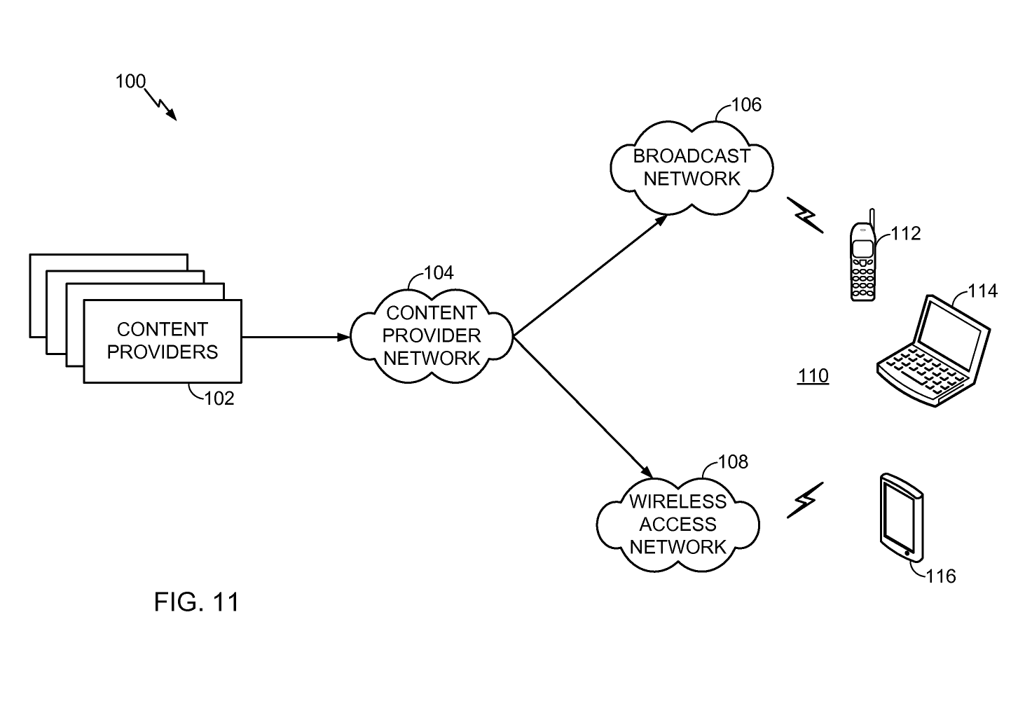

FIG. 11 shows a communications system 100 in which principles according to the present work may be incorporated. In general, the system 100 creates and broadcasts multimedia content across various networks to a large number of mobile subscribers. The communications system 100 includes any number of content providers 102, a content provider network 104, a broadcast network 106, and a wireless access network 108. The communications system 100 is also shown with a number of devices 110 used by mobile subscribers to receive multimedia content. These devices 110 include a mobile telephone 112, a personal digital assistant (PDA) 114, and a laptop computer 116. The devices 110 illustrate just some of the devices that are suitable for use in the communications systems 100. It should be noted that although three devices are shown in FIG. 11, virtually any number of analogous devices or types of devices are suitable for use in the communications system 100, as would be apparent to those skilled in the art.

The content providers 102 provide content for distribution to mobile subscribers in the communications system 100. The content may include video, audio, multimedia content, clips, real-time and non real-time content, scripts, programs, data or any other type of suitable content. The content providers 102 provide content to the content provider network for wide-area or local-are distribution.

The content provider network 104 comprises any combination of wired and wireless networks that operate to distribute content for delivery to mobile subscribers. In the example illustrated in FIG. 11, the content provider network 104 distributes content through a broadcast network 106. The broadcast network 106 comprises any combination of wired and wireless proprietary networks that are designed to broadcast high quality content. These proprietary networks may be distributed throughout a large geographic region to provide seamless coverage to mobile devices. Typically, the geographic region will be divided into sectors with each sector providing access to wide-area and local-area content.

The content provider network 104 may also include a content server (not shown) for distribution of content through a wireless access network 108. The content server communicates with a base station controller (BSC) (not shown) in the wireless access network 108. The BSC may be used to manage and control any number of base transceiver station (BTSs) (not shown) depending on the geographic reach of the wireless access network 108. The BTSs provide access to wide-area and local-area for the various devices 110.

The multimedia content broadcast by the content providers 102 includes one or more services. A service is an aggregation of one or more independent data components. Each independent data component of a service is called a flow. By way of example, a cable news service may include three flows: a video flow, an audio flow, and a control flow.

Services are carried over one of more logical channels. In FLO applications, a logical channel is often referred to as a Multicast Logical Channel (MLC). A logical channel may be divided into multiple logical sub-channels. These logical sub-channels are called streams. Each flow is carried in a single stream. The content for a logical channel is transmitted through the various networks in a physical frame. In FLO applications, the physical frame is often referred to as a superframe.

The air interface used to transmit the physical frames to the various devices 110 shown in FIG. 11 may vary depending on the specific application and the overall design constraints. In general, communication systems employing FLO technology utilize Orthogonal Frequency Division Multiplexing (OFDM), which is also utilized by Digital Audio Broadcasting (DAB), Terrestrial Digital Video Broadcasting (DVB-T), and Terrestrial Integrated Services Digital Broadcasting (ISDB-T). OFDM is a multi-carrier modulation technique that effectively partitions the overall system bandwidth into multiple (N) sub-carriers. These sub-carriers, which are also referred to as tones, bins, frequency channels, etc., are spaced apart at precise frequencies to provide orthogonality. Content may be modulated onto the sub-carriers by adjusting each sub-carrier's phase, amplitude or both. Typically, quadrature phase shift keying (QPSK) or quadrature amplitude modulation (QAM) is used, but other modulation schemes may also be used.

Exemplary embodiments of the present work provide for utilization of the Positioning Pilot Channel (PPC) in a FLO receiver using hardware (HW), that is, without requiring execution of a data processing application on a data processor. The present work enables 2K mode, 4K mode and 8K mode of operation of the receiver. Core PPC functionality including WID/LID identification, channel estimation and channel power computation is supported. PPC enhancements including propagation delay estimation (based on the first arriving path for example), interpolation algorithms to refine the delay estimate and other delay spread estimation techniques may be implemented by applications implemented on a DSP or similar data processor (also referred to herein as QDSP). In some embodiments, the hardware design is capable of interfacing to a QDSP to support this enhanced functionality. Hardware operations are controlled by software residing in either a controlling microprocessor or the QDSP.

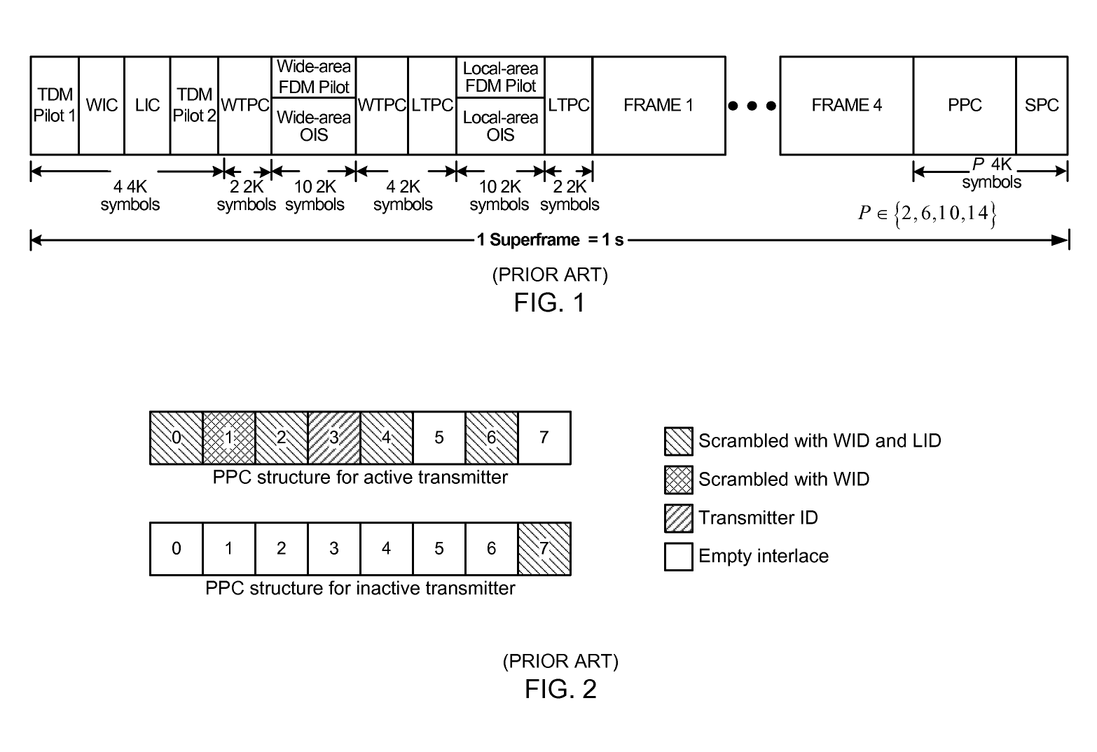

PPC in FLO is a set of dedicated OFDM symbols towards the end of every FLO superframe which are designed to help in transmitter identification and even positioning functionality using FLO signals in the future. The PPC symbols occur at a fixed location with respect to the end of the superframe. The superframe structure according to the aforementioned FLO standard is shown in FIG. 1.

It can be seen that the FLO superframe always ends in the Signal Parameters Channel (SPC) which comprises two OFDM symbols of fixed duration across all the FFT modes as well as cyclic prefix options. In particular, each SPC symbol occupies 4625 chips across all the modes. PPC symbols occur immediately preceding the SPC symbols.

PPC Numerology

The PPC numerology depends on the FFT mode of operation. Similar to the data symbols, PPC symbols follow the notion of MAC units and PHY symbols. Across all the FFT modes, PPC symbols consist of 8 MAC units. The mapping of MAC units to PHY symbols changes across FFT modes. In particular, each MAC unit maps to 1 PHY symbol in 4K mode while each MAC unit maps to 2 PHY symbols in 2K mode. PPC PHY symbol duration and cyclic prefix used for each of the FFT modes is as follows.

4K Mode:

FFT window=4096 chips

Cyclic prefix=2048 chips

Window length=17 chips

Total PPC symbol duration=6161 chips

There will be 8 PPC symbols in each superframe occupying a total of 8×6161=49288 chips.

2K Mode:

FFT window=2048 chips

Cyclic prefix=1024 chips

Window length=17 chips

Total PPC PHY symbol duration=3089 chips

There will be 8 PPC MAC units mapping to 16 PHY symbols in each superframe occupying a total of 16×3089=49424 chips. The above numerology for 2K and 4K FFT modes are independent of the cyclic prefix used for the data symbols.

8K Mode:

FFT window=8192 chips

Cyclic Prefix=4096 chips

Window Length=17 chips

Total PPC PHY symbol duration=12305 chips

PPC Interlace Structure

During each PPC symbol, the corresponding transmitter is in one of two transmission states, viz., active state or an inactive state. The PPC symbol waveform transmitted depends on the state of the transmitter. Transmitters are scheduled to be in an active state in a round robin fashion. The transmitters follow a deterministic schedule in alternating between the active state and the inactive state. However, the receiver processing will be independent of the scheduling taking place at the transmitters. The scrambler seed referred to in the following discussion is the 20-bit seed specified in AIS (TIA-1099-A) given by:

d3d2d1d0 c3c2c1c0 b0 a10a9a8a7a6a5a4a3a2a1a0

where

a10a9a8a7a6a5a4a3a2a1a0—correspond to the OFDM symbol index

b0—reserved bit set equal to 1

c3c2c1c0—LID (Local area differentiator)

d3d2d1d0—WID (Wide area differentiator).

Active State Transmissions

In an active state, the FLO transmitter transmits pilots on four interlaces of the PPC symbol (see FIG. 2). The interlaces used for pilots are 0, 2, 4 and 6. Note that a given interlace, say interlace n (where n=1, 2, . . . 7), may also be referred to herein in the abbreviated format “In” (where n=1, 2, . . . 7). In addition to the pilots, the transmitter also sends additional information in two slots of the MAC unit. Note that PPC symbols employ identity slot to interlace mapping so that a particular slot index maps to the same interlace index as well. Slot index 1 (mapping to interlace 1 for 1K, 2K and 4K modes while mapping to half interlace 1 in the case of 8K mode) is used to convey information about the WID used for the symbol. The LID is deterministically set to 0000 for this interlace. Pilots in interlaces 0, 2, 4 and 6 are scrambled using both WID and LID information pertaining to the transmitter. In some embodiments, the receiver first decodes WID from interlace 1 and uses the derived WID information on one of the remaining four interlaces (interlace 0 for example) to decode the LID. The WID and LID information is then used, together with the pilots on the four uniformly spaced interlaces 0, 2, 4 and 6, to compute channel estimates and the signal power received at the receiver.

In addition to the pilots and the WID bearing interlace, the active transmitter also sends transmitter ID information in slot 3 (which maps to interlace 3 in all modes except 8K mode where it maps to an half interlace of interlace 3). 56-bits of information are conveyed in slot 3 which can be decoded at the receiver to result in the transmitter ID as well as additional bits that signal if the current transmitter uses any of the succeeding PPC symbols for transmitting any other information.

The scrambling seed and the slot to interlace map used for the active state transmissions are summarized below. Note that, in some embodiments, the descrambling block at the receiver takes the following into account for descrambling the PPC symbols.

Interlaces 0, 2, 4 and 6:

WID and LID as specified at the transmitter as part of the network deployment.

Interlace 1:

WID as specified at the transmitter, LID set to 0000. In 8K mode, only the first half interlace of Interlace 1 is used.

Interlace 3:

WID, LID as specified at the transmitter (same as pilot interlaces 0, 2, 4 and 6). In 8K mode, only the first half of interlace 3 is used corresponding to the even MAC index mapping into the PHY symbol.

Symbol index used in scrambling: PPC MAC unit index (ranging from 0 through 7 in the superframe). PPC MAC unit index is used since the number of data symbols is a function of the mode and the cyclic prefix used which in turn makes PPC processing dependent on other parameters. In 8K mode, PPC MAC index ranges from 0 through 15 since each PHY symbol carries two MAC time units. While the pilots (on I0, I2, I4 and I6) are carried on all the MAC time units, WID information and transmitter ID (slots 1 and 3) are carried only on the even MAC time units.

Slot to interlace map: Some embodiments use the identity slot to interlace map for determining the scrambler mask for the PPC symbols. Therefore, interlace 0 will be mapped back to slot 0, interlace 1 to slot 1 and so on.

Inactive State Transmissions

While the receiver processing is essentially based on PPC symbols that are part of active state transmissions, the inactive state transmission structure is specified here for the sake of completion. During the inactive state, only one interlace (Interlace 7) is used for transmission (see FIG. 2). The transmission on interlace 7 in this case is a dummy transmission to ensure that the total energy per OFDM symbol is kept constant. Interlace 7 is scrambled using WID, LID and the PPC symbol index available at the transmitter. The slot to interlace map used can be the identity map as in the case of the active state transmissions. FIG. 2 summarizes the interlaces used for the active and inactive PPC transmissions. In 8K mode, the entire interlace comprising of two MAC time units is used for transmission.

Receiver Processing

For each PPC symbol, the receiver performs the following operations in some embodiments to arrive at the transmitter identification information:

(Step 1) Measure time domain (TD) energy of samples from interlace 1 and interlace 5. Use energy from interlace 1 to determine thresholds for WID and LID detection. In some embodiments, energy from interlace 5 is used to generate the threshold for channel estimation.

(Step 2) Determine the strongest WID using slot 1 (same as interlace 1 in all cases except 8K mode where it is half interlace 1).

(Step 3) Determine the strongest LID using slot 0 and the WID determined in step 2 above.

(Step 4) Use the WID and LID information obtained to compute a time domain channel estimate (TDCE) from interlaces 0, 2, 4 and 6. This channel estimate (CE) will be used to compute the received signal power from that particular transmitter.

(Step 5) Use the time domain channel estimate to obtain a frequency domain channel estimate (FDCE) for slot 3. LLRs are generated for slot 3 which are then used to decode the transmitter ID at the receiver.

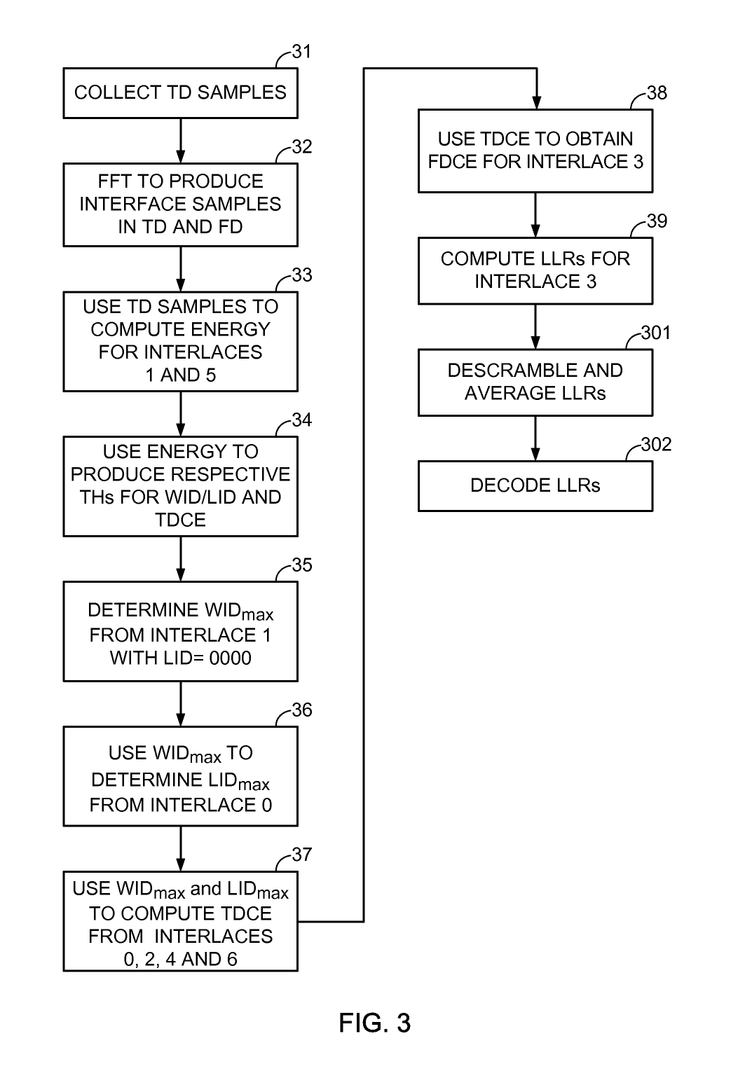

Some embodiments use receiver hardware to perform the above sequence of steps for all the PPC symbols in every superframe. In some embodiments, the receiver performs the entire sequence of operations (especially step 4 above) if and only if it determines that the received signal strength in the PPC symbol of interest is significant enough. FIGS. 3-6 illustrate in more detail a sequence of operations performed by the receiver in some embodiments to carry out steps 1-5 above. With reference to FIGS. 3-6, this sequence of operations is as follows according to some embodiments.

4K Mode Processing

From each PPC PHY symbol, collect time domain samples corresponding to the FFT size. In the case of 4K mode, 4K input samples will be collected by FFT before the start of processing. See 31 in FIG. 3.

Using the time domain input samples, form time domain interlace samples corresponding to each of the eight interlaces. For the 4K mode, this operation corresponds to the first stage of the 4K FFT. See 32 in FIG. 3.

Measure energy of samples from a populated interlace and an empty interlace. Some embodiments use interlace 1 as the populated interlace, and interlace 5 as the empty interlace. In some embodiments, the energy computations are done sequentially since the underlying time domain samples come from the same FFT memory. See 33 in FIG. 3.

Energy measured will be used to determine thresholds (THs) for use in various operations including WID/LID determination and time domain channel estimation. See 34 in FIG. 3. In some embodiments, the threshold computation is based on the measured energies, and is performed in HW. In some embodiments, the measured energy is also used to determine FFT scale factors to be used for processing the current PPC symbol.

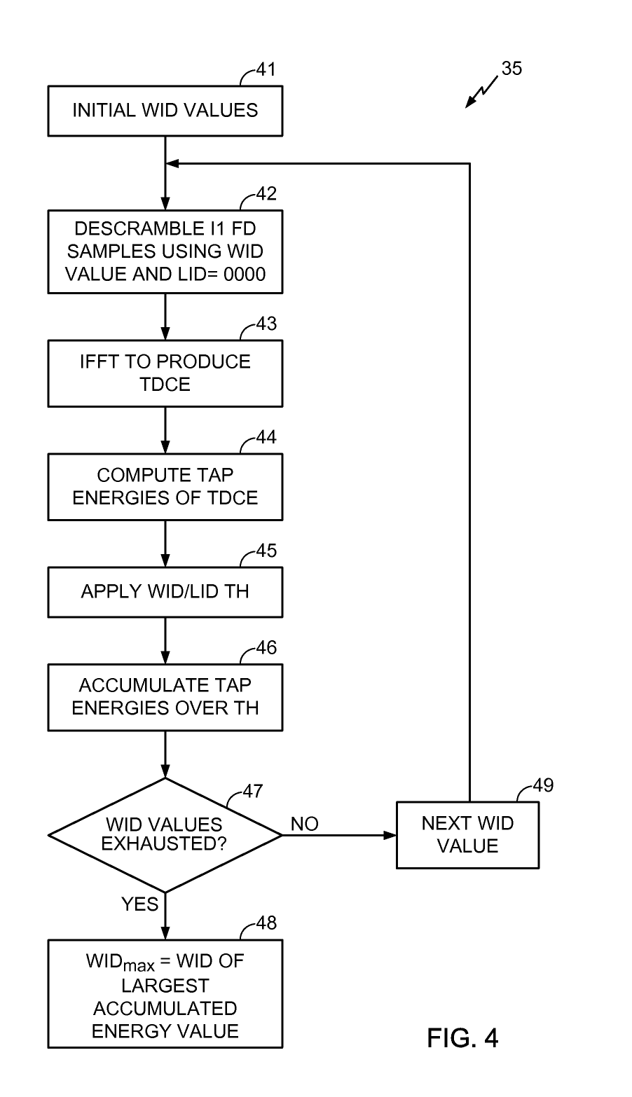

The TD interlace samples output from the first stage of the 4K FFT are used to compute the strongest WID (also referred to herein as WIDmax) and the strongest LID (also referred to herein as LIDmax) for the PPC symbol. WIDmax is determined from TD samples from I1, and is thereafter used to determine LIDmax from TD samples from I0. See 35 and 36 in FIGS. 3 and 4.

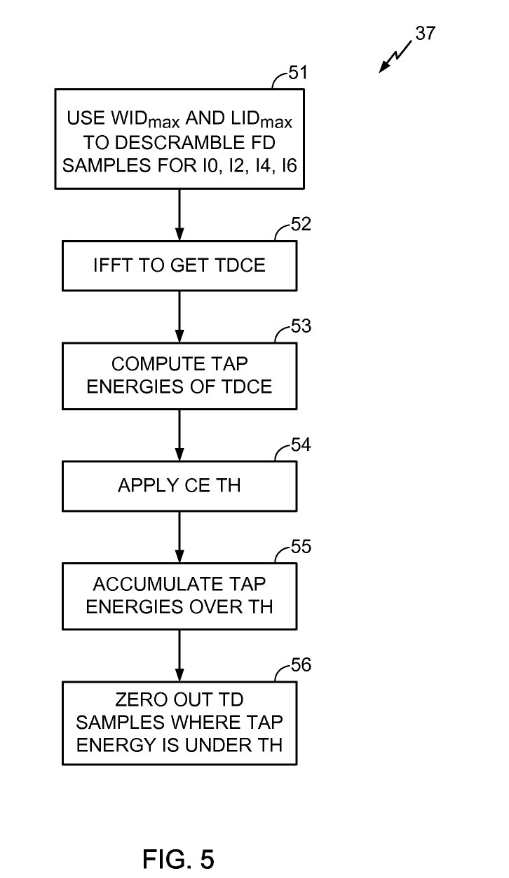

WIDmax and LIDmax are used to descramble interlaces 0, 2, 4 and 6. A 2K point (pt) IFFT is performed on the four interlaces (0, 2, 4 and 6) to result in 2K pt TDCE. See 37 in FIG. 3; also see 51 and 52 in FIG. 5.

The time domain channel estimate is then thresholded to remove noise. In some embodiments, the thresholded values are stored in a separate buffer so that the unthresholded values are available to be read by QDSP. For the thresholding operation in the time domain, the energy in each tap is computed (see 53 in FIG. 5) and compared to a threshold (see 54 in FIG. 5). If the energy exceeds the threshold, it is added to an accumulator; otherwise, the corresponding time domain samples are set to zero and the accumulator is not updated. See 55 and 56 in FIG. 5.

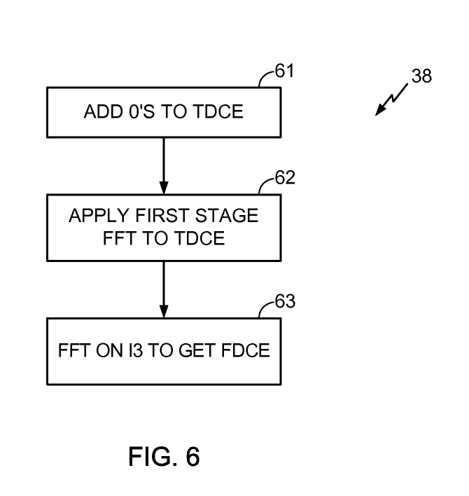

After energy computations, a frequency domain channel estimate (FDCE) corresponding to slot 3 needs to be computed from the time domain channel estimate. See 38 in FIG. 3. This is obtained by performing a 4K FFT on the 2K time domain channel estimate. Before performing the 4K FFT, the last 2K memory locations are set to zero. See 61 in FIG. 6. Then the first stage of 4K FFT is performed on the resulting 4K samples (2K thresholded IFFT samples+2K zeros at the end). See 62 in FIG. 6. After the first stage FFT, one 512 pt FFT is performed on interlace 3 to obtain the frequency domain channel estimate. See 63 in FIG. 6.

LLRs are computed for slot 3 from the FDCE and the data FFT. See 39 in FIG. 3. Note that QPSK symbols are transmitted on slot 3 used for transmitter ID.

LLRs are descrambled, and then averaged such that 1000 LLRs are reduced to 250 LLRs. See 301 in FIG. 3. In some embodiments, the averaging picks four consecutive LLRs, and averages them to give one LLR.

In some embodiments, an interrupt for the QDSP is fired after the LLR descrambling and averaging is complete, to indicate that the LLRs and channel estimate are ready to be read and processed by the QDSP in order to recover the transmitter ID and signaling bits.

When the QDSP is available, LLRs are decoded and transmitter ID along with the signaling bits are recovered. See 302 in FIG. 3. The signaling bits are then used by the QDSP to indicate if (and how) the succeeding PPC symbols should be processed by the HW.

Details of the operation described above with respect to FIGS. 3-6 are set forth below according to various embodiments of the present work.

In some embodiments, PPC processing in HW is initiated by microprocessor software loading a register in HW. The HW will either process all the PPC symbols in a superframe or none. The PPC symbols include three-bits to signal the use of succeeding symbols for transmitter specific channel uses (where the signal waveform could be different). Some embodiments process all PPC symbols assuming the PPC waveform. Software (SW) or firmware discards some symbols if they do not follow the PPC waveform design. In some embodiments, the processing described below is carried out for each of the eight PPC symbols in the superframe when a predetermined register bit is set by the microprocessor SW.

Energy Measurement on Time Domain Samples

4K mode: In some embodiments, 4K time domain samples x(n), n=0, 1 . . . 4095, at 7-bit resolution for I and Q are processed by an FFT block to generate the time domain interlace samples corresponding to all the eight interlaces (see 32 in FIG. 3). Energy corresponding to interlaces 1 and 5 are computed (see 33 in FIG. 3) for setting the thresholds at various stages. Let the 512 samples corresponding to interlace 1 be denoted by y₁ (n), n=0, 1, 2, . . . 511.

Let E₁ correspond to the energy in the interlace 1. Then,

$${E}_{1} = {\sum }_{n = 0}^{511} ( {{y}_{1 , I} ( n )}^{2} + {{y}_{1 , Q} ( n )}^{2} ) .$$

Similarly, the energy in interlace 5 is computed from interlace 5 time domain samples.

$${E}_{5} = {\sum }_{n = 0}^{511} ( {{y}_{5 , I} ( n )}^{2} + {{y}_{5 , Q} ( n )}^{2} ) .$$

The energy computation is done after the first stage of the 4K FFT. With a scale factor of 0.5 for the 8-pt FFT, the energy per sample comes out to be 8*(8/6)*(1/4) times the input sample variance which amounts to 0.423. Therefore, the energy per interlace works out to be 216.81 (when the dominant transmitter is active).

2k mode: In 2K mode, each PHY symbol contains 2K samples for FFT. Correspondingly, energy measurements are performed on 256-pt time domain interlace samples for each of the two interlaces (interlace 1 and interlace 5). That is

$${E}_{1} = {\sum }_{n = 0}^{255} ( {{y}_{1 , I} ( n )}^{2} + {{y}_{1 , Q} ( n )}^{2} )$$

$$and$$

$${E}_{5} = {\sum }_{n = 0}^{255} ( {{y}_{5 , I} ( n )}^{2} + {{y}_{5 , Q} ( n )}^{2} ) .$$

Note that this computation needs to be performed for only the first PHY symbol (P0) out of the two comprising the MAC unit. The energy computation process is the same as described above for the 4K mode.

8k mode: In 8K mode, each PHY symbol contains 8K samples for FFT and corresponds to two MAC units. However, WID and data are transmitted in only one MAC unit which corresponds to one half-interlace (or the first half-interlace) of interlace 1 and interlace 3 respectively. Some embodiments measure the energy in the half interlace 1 and also in the first half interlace of 5. Energy computation is similar to the 4K mode with 512 samples used for computation.

The energy computations described above are readily implemented using conventional multiplier, adder and accumulator hardware.

FFT Scale Factors and Thresholds Based on Measured Energy

Useful signal energy E₁ (defined above) and the noise variance estimate E₅ (defined above) are used to determine:

thresholds for WID/LID detection, channel estimation and computation of signal energy from transmitter of interest.

In some embodiments, the scale factors for FFT processing of the PPC symbol may be adapted depending on the signal strength received. That is, one set of scale factors may be used for the active state of a transmitter that may be received at a higher signal strength and a different set of scale factors may be used for the active state of a transmitter whose signal may be received at a lower signal strength. This helps reduce the effect of quantization noise from FFT processing resulting from the stronger interferers.

Acquisition of WID/LID

The WID/LID acquisition is similar in both the 2K and 4K modes of operation. In some embodiments, the WID/LID determination process follows along the lines of conventional WIC/LIC processing. In some embodiments, WID and LID determined by the HW for each PPC symbol (MAC unit) can be stored to be read by SW.

In some embodiments, the WID/LID information used for PPC processing may be programmed by the software based on some pre-programmed information instead of going through the WID/LID acquisition procedure described here. Such pre-programmed information would help in improving the performance of the PPC processing algorithm since the noise contribution from the corresponding interlaces would not affect PPC processing.

WID Detection

In some embodiments, WID information is determined using interlace 1. For this interlace, LID used for scrambling is deterministically set to 0000. In some implementations, the basic idea behind WID/LID detection is to compute the time domain channel estimate for each hypothesis of WID/LID combination, remove noise by thresholding and then pick the WID/LID corresponding to the maximum energy as the winning hypothesis.

In some embodiments, LID detection from interlace 0 follows along similar lines as WID detection from interlace 1. Referring first then to WID detection, it is assumed that the 512 frequency domain (FD) samples corresponding to slot 1 are available. See 32 in FIG. 3. Note that the required frequency domain samples are obtained from one PHY symbol in the case of 4K mode while the frequency domain samples are constructed from two PHY symbols in the case of 2K mode. Zero extrapolation is performed to null out the 12 subcarriers in the guard band. Frequency domain samples are descrambled assuming a particular WID. See 41 and 42 in FIG. 4. A 512-pt IFFT is then computed using the descrambler output to arrive at the time domain channel estimate. See 43 in FIG. 4. Also, energy corresponding to the time domain samples of interlace 1 are computed from the interlace 1 samples. See 44 in FIG. 4. This energy reference is then used to perform thresholding for the time domain channel estimate values. See 45 in FIG. 4. For performing thresholding in some embodiments, the energy in each tap is computed and compared against a reference formed by using a constant factor programmed by software and the energy of interlace 1 computed from time domain samples, as described herein below.

Energy from all the channel taps exceeding the threshold is accumulated and stored against that particular WID value. See 46 in FIG. 4. The process of descrambling, 512-pt IFFT, thresholding and energy computation is repeated for all the 16 possible WID values, 0000-1111. See 47 and 49 in FIG. 4. All the sixteen energy values are then compared and the WID value corresponding to the maximum energy, referred to herein as WIDmax, is declared as the winning hypothesis. See 48 in FIG. 4.

Frequency Domain Samples for Slot 1

8K mode: Frequency domain samples are obtained by performing a 1024-pt FFT on the time domain samples on interlace 1 (obtained after the first stage of 8K FFT on the input samples).

4K mode: Frequency domain samples are obtained by performing a 512-pt FFT on the time domain samples from interlace 1 (obtained after the first stage of 4K FFT on the input samples). See 32 in FIG. 3.

2K mode: The 512 samples corresponding to slot 1 are constructed from interlace 1 in P0 and interlace 1 in P1. In particular, a 256-pt FFT on interlace 1 samples in P0 results in the first 256 frequency domain samples of slot 1 (I₁) (sample numbers 0 through 255). Similarly, a 256-pt FFT on interlace 1 samples in P1 results in samples 256 through 511 (I′₁) for slot 1. These samples are put together to arrive at the 512 frequency domain samples for slot 1. Frequency domain samples are put together in a similar fashion for other slots as well.

Descrambling in WID/LID Detection

After obtaining the frequency domain samples, hypothesis testing is performed using the 16 possible scrambler seeds corresponding to the 4-bits for the WID field in the scrambler seed. See 35 in FIGS. 3 and 5. Note that the 4-bits corresponding to the LID field are all set to 0 while descrambling interlace 1. See 42 in FIG. 4. However, while descrambling interlace 0 to determine LID, the WID field is set to the WIDmax value determined as a result of processing interlace 1 (see 35 in FIGS. 3 and 5), while varying the LID field through all the combinations from 0000 through 1111 (see 36 in FIG. 3). The scrambler seed and mask parameters for various interlaces (slots) are as follows:

Slot 1:

Symbol index=PPC symbol index (ranging from 0 through 8)

LID field=0000

WID field=all combinations from 0000 through 1111

Slot index=1 (since identity slot to interlace map is used)

Slots 0, 2, 3, 4, 6:

Symbol index=PPC symbol index (same as the one used for interlace 1)

LID field=all combinations from 0000 through 1111

WID field=as determined from interlace 1

Slot index=pick the corresponding slot index (identity slot to interlace map)

If the scrambler output corresponding to the k th subcarrier in the interlace 0 corresponding to the i th hypothesis (i goes from 0 through 15) is given by Sᵢ(k), then the descrambler output is given by:

Hᵢ(k)=Y(k)Sᵢ*(k)

Note that Sᵢ(k) is obtained by mapping the scrambler output [b₂ₖb₂ₖ₊₁] to the QPSK constellation. Multiplication by Sᵢ*(k) is accomplished as a clockwise rotation by a multiple of π/2 as shown in Table 1 followed by a clockwise rotation by π/4 (given by 1−j ignoring scaling by

$$\frac{1}{\sqrt{2}} ) .$$

TABLE 1
Descrambling operation based on the scrambler output

| (b₂ₖ₊₁ b₂ₖ) (from scrambler) | Angle of rotation (degrees) |
|---|---|
| 00 | 0 |
| 01 | 90 |
| 11 | 180 |
| 10 | 270 |

In some embodiments, the hardware operation for descrambling is the same as that conventionally used for descrambling of pilot symbols in channel estimation, WIC/LIC symbols and SPC symbols.

Descrambling in 2K Mode:

The indexing to be used for descrambling in the 2K mode should take the interlace construction into account. In particular, the descrambler in the 2K mode with a particular mask produces 500-bits (corresponding to 250 QPSK symbols). This will cover one half of the interlace out of the total 500 QPSK symbols. Descrambling bits for the remaining half are generated using the second set of masks associated with each interlace in the 2K mode. Consider a particular interlace with symbols labeled as Y(0), Y(1) through Y(511). Note that Y(0) through Y(255) correspond to one PHY symbol (P0) while Y(256) through Y(511) correspond to the next PHY symbol (P1). The descrambler works on each of these 256 symbols separately. In particular, using the mask associated with P0, the descrambler starts at Y(131), goes through Y(255) and then wraps around to Y(0) through Y(124). Essentially, the first set of guard subcarriers are mapped in the region Y(125) through Y(130).

Similarly, using the mask associated with P1, the descrambler starts at Y(387) through Y(511) and then wraps around to Y(256) through Y(380). The guard subcarriers for the second half are mapped between Y(381) and Y(386).

The indexing for interlace 0 is slightly different. This is due to the presence of the guard subcarrier at DC. In particular, for P0, the indexing for descrambling starts at Y(131) through Y(255) and then wraps around to Y(1) through Y(125). The guard subcarriers are mapped to Y(0) and Y(126) through Y(130). Similarly, for P1, the indexing for descrambling starts at Y(387) through Y(511) and then wraps around to Y(257) through Y(381). The guard subcarriers are mapped to Y(256) and Y(382) through Y(386).

Descrambling in 8K Mode:

The PHY PPC index is used to generate the scrambler output for each of the interlaces. While only one half of interlace 1 is occupied, HW descrambling will still be performed on all the 1000 subcarriers. Interlaces 0, 2, 4 and 6 use all the 1000 subcarriers and hence the full interlace needs to be descrambled.

Zero Extrapolation in WID/LID Detection

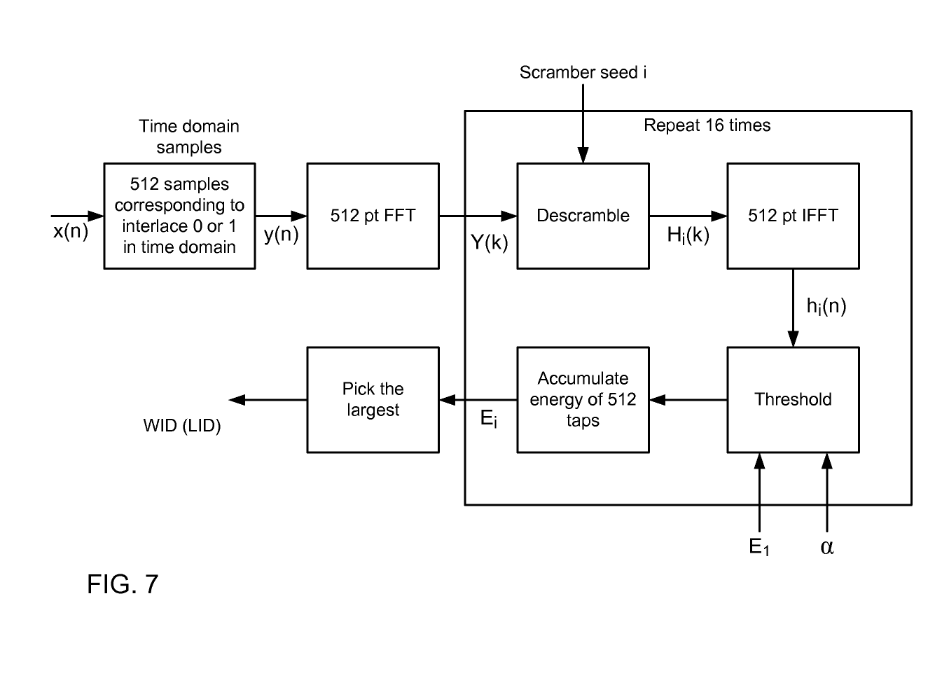

Some embodiments perform a zero extrapolation on the descrambler output, shown as Hᵢ(k) in FIG. 7. Zero extrapolation (not explicitly shown in FIG. 7) is slightly different for 2K mode compared to 4K mode since the location of guard subcarriers is different.

4K mode:

Slot 0: k=0 (DC) and k=251 through 261 are set to zero

Other slots: k=250 through 261 are set to zero

2K mode:

Slot 0: k=0 (DC) and k=126 through 130, k=256 (DC again) and k=382 through 386 are set to zero

Other slots: k=125 through 130 and k=381 through 386 are set to zero

8K mode:

Slot 0: k=0 (DC) and k=501 through 523 are set to zero

Other slots: k=500 through 523 are set to zero

512-pt IFFT

After zero extrapolation, there are 512 values for Hᵢ(k). Then a 512-pt IFFT (see FIG. 7) is performed on the extrapolated values for WID hypothesis i to obtain the corresponding time domain samples. See also 43 in FIG. 4. The IFFT operation on the extrapolated values Hᵢ(k) is given by (with normalization as in the hardware):

$${h}_{i} ( l ) = \frac{1}{64} {\sum }_{k = 0}^{511} {H}_{i} ( k ) {e}^{\frac{j2 πi k}{512}} , for l = 0 , 1 , 2 … 511.$$

The output of the IFFT operation is a time domain channel estimate given by {hᵢ(n)} shown in FIG. 7, and corresponding to the transmitter using the scrambling pattern with the WID given by index i. The estimate {hᵢ(n)} includes 512 time domain samples, each of which is a complex number with real and imaginary parts.

8K mode:

In 8K mode, for WID determination using interlace 1, the initial FFT and the descrambling operations use 1024 subcarriers. However, for IFFT only 512 active subcarriers (corresponding to the first half of the interlace, after zero extrapolation) are used. Therefore, only a 512-pt IFFT is performed for each hypothesis for WID.

Thresholding and Energy Measurement in WID/LID Detection

After obtaining the time domain channel estimate (see 43 in FIG. 4), energy in each tap is computed and compared to a threshold value (see 44 and 45 in FIG. 4). The threshold value is obtained using E₁ defined above, and a value α set by the software depending on the comparison of the energy from interlace 1 with a reference energy. Some embodiments use α=10 for WID/LID detection. The actual threshold β is given by the product of the two numbers:

β=α×E₁

In some embodiments, to avoid multipliers in hardware, α is chosen to be of the form (1+2⁻ⁿ^{₁})×2⁻ⁿ^{₂}. In some embodiments, SW provides values for n₁ and n₂ in a register. The register bits correspond to n₁ and n₂ used to determine a for conventional WIC/LIC detection and channel estimation as follows:

Bits 7:0—n₁ used for WIC/LIC

Bits 15:8—n₂ used for WIC/LIC

Bits 23:16—n₁ used for channel estimation

Bits 31:24—n₂ used for channel estimation

With this structure for α, the threshold β can be calculated in HW using adders and shift operations. Some embodiments use the same HW to calculate β for thresholding in channel estimation as well.

The following pseudo code illustrates the process that some embodiments use for determining the accumulated, thresholded energy Eᵢ associated with the hypothesis i:

```
Eᵢ = 0;
for l = 0..511
    if |hᵢ(l)|² ≧ β
      Eᵢ = Eᵢ + |hᵢ(l)|²;
    end;
end;
```

The above steps corresponding to descrambling through thresholding and energy measurement are repeated for all 16 WID hypotheses. After collecting energies Eᵢ for i=0, 1, . . . 15 corresponding to the 16 hypotheses, the index i for which Eᵢ the maximum will be the best hypothesis. See FIG. 7.

Because only the maximum accumulated energy is of interest, the sorting to find the maximum can be done online as each scrambler seed is being applied. Some embodiments implement the following algorithm:

MaxEnergy=0, WIDmax=0000 (binary)

For i=0 . . . 15

If Eᵢ>MaxEnergy,

MaxEnergy=Eᵢ; WIDmax=i (in four-bit binary representation)

end.

Testing all 16 combinations for the WID produces WIDmax, that is, the WID value which results in the maximum energy for the channel estimate in the time domain. The WID field in the scrambler seed is set equal to WIDmax for descrambling all the OFDM symbols in the superframe. In some embodiments, the HW provides all WID indices and their corresponding energies at the end of WID processing for each PPC symbol.

LID Detection

In some embodiments, the steps involved in the detection of LID, i.e., the determination of LIDmax are almost identical to those described above for the detection of WID. See 36 in FIG. 3. The differences between the two are as follows in some embodiments:

Samples corresponding to slot 0 are used for LID instead of slot 1 as for WID. Note that some embodiments may use slots 2, 4 or 6 also for determining LID.

The scrambling sets the WID field equal to the WIDmax detected for that PPC symbol from interlace 1.

DC subcarrier is one of the guard subcarriers in this case. It is accounted for as explained above.

8K Mode:

In 8K mode, the only difference between WID detection and LID detection is the size of the IFFT after the pilot descrambling operation. While WID detection uses a 512-pt IFFT (on every other subcarrier of interlace 1), LID detection uses a 1K pt IFFT on all the subcarriers of interlace 0.

FIG. 7 diagrammatically illustrates a HW apparatus capable of performing the WID/LID detection operations in FIGS. 3 and 4 according to exemplary embodiments of the present work. In FIG. 7, Y(k) represents the FD samples at 42 in FIG. 4, Hᵢ(k) represents the descrambler output, and hᵢ(n) represents the TDCE at 43 in FIG. 4. The threshold block corresponds to the operations at 44 and 45 in FIG. 4.

Channel Estimation

After WID/LID have been computed in the HW, the next step is to obtain the time domain channel estimate using the pilots in interlaces 0, 2, 4 and 6. See 37 in FIG. 3. In some embodiments, the channel estimation is based on a least squares approach as used in conventional data demodulation. However, the number of pilots available (four interlaces) in PPC symbols is four times the number available in the data symbol pilot interlace. Some embodiments execute the following sequence:

Collect time domain samples from the PPC PHY symbol. See 31 in FIG. 3.

4K Mode:

Form time domain interlace samples for interlaces 0, 2, 4 and 6. See 32 in FIG. 3. Perform 512-pt FFT on each of the interlaces to obtain frequency domain samples. See 32 in FIG. 3.

2K Mode:

Form time domain interlace samples for interlaces 0, 2, 4 and 6 from the first PHY symbol P0. Perform 256-pt FFT on each of the interlaces. Repeat the same operations on the second PHY symbol P1. Combine the frequency domain samples for each interlace from P0 and P1 in the frequency domain. (8K mode) Form the time domain interlace samples for interlaces 0, 2, 4 and 6. Perform 1K-pt FFT on each of the four interlaces (actually 1K-pt FFT on interlace 4 is already performed as part of LID detection by this time) to obtain frequency domain samples.

Descramble the pilots on the four interlaces. See 51 in FIG. 5.

Some embodiments perform zero extrapolation to fill in the guard subcarriers with zero. In the case of interlace 0, the DC subcarrier at 0 should be accounted for. In the case of remaining interlaces, all the subcarriers are concentrated between 250 and 261 in the 4K mode. In the case of 2K mode (interlaces 2, 4 and 6), the guard subcarriers are located at 125 to 130 and again between 381 through 386). In 8K mode, zero extrapolation is performed for the guard subcarriers which span subcarriers 500 through 523 for interlaces 2, 4 and 6 while for interlace 0, dc subcarrier 0 along with the subcarriers 501 through 523 form the guard subcarriers.

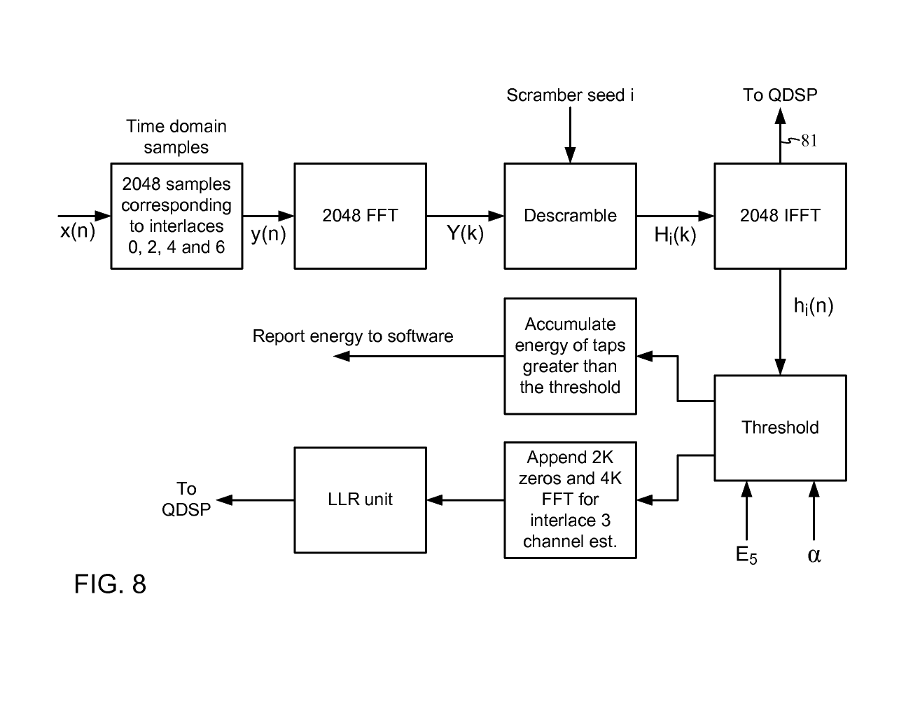

Perform 2K-pt IFFT. See 52 in FIG. 5. Store the time domain samples (unthresholded) to be read by the QDSP. See 81 in FIG. 8. In 8K mode, perform 4K-pt IFFT on the frequency domain samples from interlaces 0, 2, 4 and 6. Store the time domain samples (unthresholded) to be read by the QDSP as in the case of 2K and 4K modes.

Perform thresholding on the resulting time domain channel estimate to remove noise. See 54 in FIG. 5.

Append zeros to the 2K time domain channel estimate. See 61 in FIG. 6. Perform first stage of 4K FFT (see 62 in FIG. 6) followed by 512-pt FFT on interlace 3 (see 63 in FIG. 6) to obtain the frequency domain channel estimate. In 8K mode, append 4K zeros to result in 8K time domain samples. Perform the first stage of 8K FFT followed by 1K pt FFT on interlace 3 to obtain the frequency domain channel estimate.

Frequency Domain Interlace Samples

In some embodiments, interlace samples corresponding to different interlaces in each of the FFT modes are obtained as follows.

4K mode: Frequency domain samples are obtained by performing a 512-pt FFT on the time domain samples from the corresponding interlace (0, 2, 4 and 6).

2K mode: The 512 samples corresponding to each of the slots (0, 2, 4 and 6) are constructed from the corresponding interlace in P0 and also the corresponding interlace in P1. For example, 256-pt FFT on interlace 0 samples in P0 results in the first 256 frequency domain samples of slot 0 (I₀) (sample numbers 0 through 255). Similarly, 256-pt on interlace 0 samples in P1 results in samples 256 through 511 (I′₀) for slot 0. These are the put together to produce the 512 frequency domain samples for slot 0. Frequency domain samples are put together in a similar fashion for other slots as well.

Let the 512 samples corresponding to interlace m be denoted by Yₘ(k), k=0, 1, 2, . . . 511.

8K mode: Frequency domain samples are obtained by performing a 1K-pt FFT on the time domain samples from the corresponding interlace (0, 2, 4 and 6) (obtained after the first stage of 4K FFT on the input samples).

Descrambling in Channel Estimation

After obtaining the frequency domain samples, descrambling is performed using WIDmax and LIDmax and the PPC symbol index (see 51 in FIG. 5). The scrambler seed and mask parameters used in descrambling are as follows:

Symbol index=PPC symbol index (ranging from 0 through 7).

Slot index=interlace index (since identity map is used).

The descrambling is similar to that used in the WID/LID determination described above. The output of descrambling is Hₘ(k), k=0, 1, 2 . . . 511, m=0, 2, 4, 6. The ordering of samples to be used for descrambling is discussed above.

Zero Extrapolation in Channel Estimation

Some embodiments perform a zero extrapolation on Hₘ(k) similar to the zero extrapolation performed during WID/LID detection. Zero extrapolation is slightly different for 2K mode compared to 4K mode since the location of guard subcarriers is different.

4K mode:

Slot 0: k=0 (DC) and k=251 through 261 are set to zero

Other slots: k=250 through 261 are set to zero

2K mode:

Slot 0: k=0 (DC) and k=126 through 130, k=256 (DC again) and k=382 through 386 are set to zero

Other slots: k=125 through 130 and k=381 through 386 are set to zero

8K mode:

Slot 0: k=0 (DC) and k=501 through 523 are set to zero

Other slots: k=500 through 523 are set to zero

2K-pt IFFT

After zero extrapolation, there are 2048 values for H(k) (from four slots). Then, a 2K-pt IFFT operation is performed on the extrapolated values to obtain a time domain channel estimate. See 52 in FIG. 5. The output of the IFFT operation is a time domain channel estimate given by {h(l)}. The estimate includes 2048 time domain samples, each of which is a complex number with real and imaginary parts. The next step is to threshold the channel estimate to remove noise and measure energy which would correspond to the signal energy received from the transmitter active during that particular PPC symbol. In some embodiments, the unthresholded channel estimates are made available to be read by the QDSP. Storing the unthresholded channel estimates to be passed on to the QDSP also helps in the FFT memory management process.

8K mode: After zero extrapolation to obtain 4K pilot subcarriers, 4K IFFT is performed to obtain the time domain channel estimate. The bit widths are same as in 2K and 4K modes.

Thresholding and Energy Measurement in Channel Estimation

After obtaining the time domain channel estimate, energy in each tap is computed and compared to a threshold value (see 53 and 54 in FIG. 5) similar to the thresholding operation performed during WID/LID acquisition. The threshold value in this case is obtained using the interference variance estimate E₅ defined above, and a value α set by software. Some embodiments use α=12 for channel estimation. The actual threshold β is given by:

β=α×E₅

All the taps that exceed the threshold are accumulated. See 55 in FIG. 5. In some embodiments, the interference energy computed from interlace 5 is also made available to software.

The time domain channel estimates after thresholding are stored to be used to compute the frequency domain channel estimate for LLR generation. In particular, the time domain channel estimate taps whose energy fall below the chosen threshold are deterministically set to zero.

Frequency Domain Channel Estimate

After thresholding, the time domain channel estimates are used for computing the frequency domain channel estimate for slot 3 to be used for LLR generation. The generation of channel estimate is identical across 2K and 4K modes. The 2048 time domain channel estimate samples are first extended to 4096 samples by appending 2K zeros at the end. See 61 in FIG. 6. The first stage of 4K FFT is then performed to result in the time domain interlace samples for interlace 3. See 62 in FIG. 6. A 512-pt FFT is finally done on the interlace 3 samples to result in the frequency domain channel estimate to be used for LLR generation. See 63 in FIG. 6.

In the case of 8K mode, 4096 underlying time domain samples are expanded to 8K samples by appending zeroes at the end. First stage of 8K FFT is performed followed by a 1K FFT on interlace 3 samples. From the resulting 1K frequency domain channel estimate, the first half of the samples corresponding to the even MAC symbol are used for LLR generation.

In the case of 2K mode, a 256-pt FFT is performed following the initial first stage of 2K FFT to result in one half of the frequency domain samples of slot 3. The full 512 samples are obtained after processing the P0 and P1 symbols of each PPC.

FIG. 8 diagrammatically illustrates a HW apparatus capable of performing the channel estimation operations at 37 and 38 in FIGS. 3, 5 and 6 according to exemplary embodiments of the present work. In FIG. 8, Y(k) represents the FD samples at 51 in FIG. 5, Hᵢ(k) represents the descrambler output, and hᵢ(n) represents the TDCE at 52 in FIG. 5. The threshold block corresponds to the operations at 53 and 54 in FIG. 5, and the LLR unit corresponds to operations at 39 and 301 in FIG. 3.

LLR Generation for SLOT 3

The LLR generation and descrambling (see 39 and 301 in FIG. 3) for slot 3 follows the operations conventionally used to process regular data symbols (which is independent of the FFT mode). In the case of PPC, 1000 LLRs are generated for slot 3 (QPSK modulation is used), and are then combined (e.g., averaged in some embodiments) to result in 496 LLRs. See 301 in FIG. 3. In some embodiments, all the 1000 original LLRs are input to QDSP for further processing. An interrupt is generated after the LLR computation is done. QDSP will act to read the channel estimates/LLRs when this interrupt occurs.

End of PPC Processing

In some embodiments, at the end of the processing for each PPC symbol, the HW reports the interference energy computed from interlace 5 to software executing on a controlling data processor or the QDSP.

QDSP collects time domain channel estimates as well as the compressed LLRs from the HW for further processing. See, e.g., 302 in FIG. 3. QDSP starts reading compressed LLR data from the HW upon the generation of the interrupt at the end of LLR computation. By this time, the time domain channel estimates have already been generated and are therefore also available for reading by the QDSP. In some embodiments, the channel estimates are read by the QDSP through a conventional interface that provides a feature to compute the energy of the I/Q samples on the fly, which helps to reduce the required amount of storage in the QDSP and also saves computations in the QDSP during further processing.

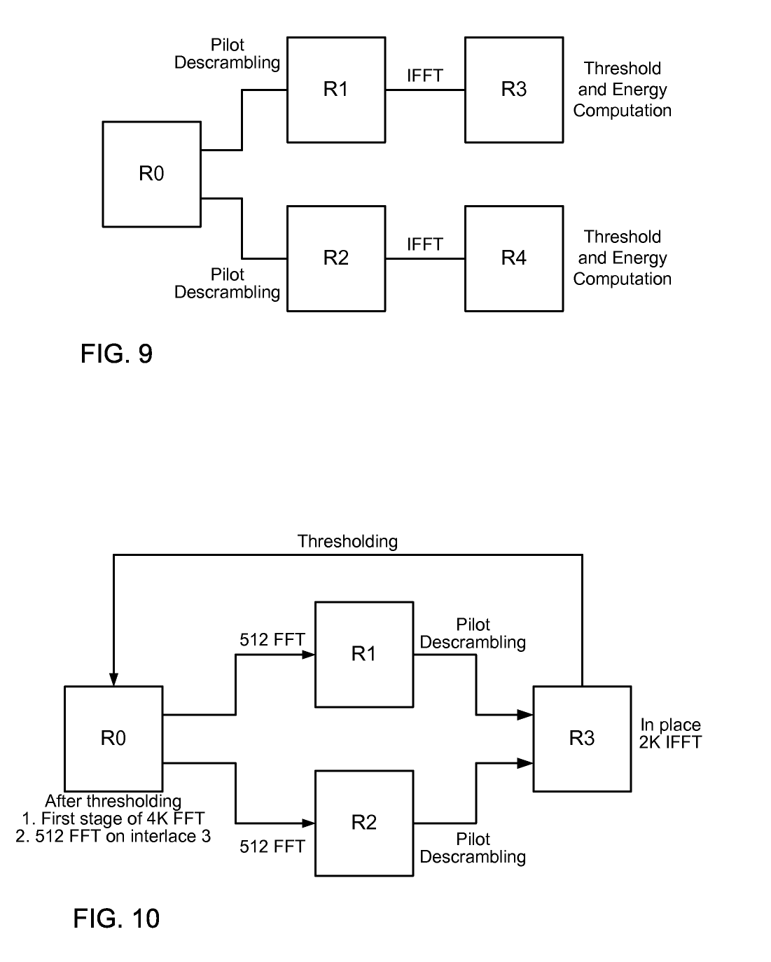

In some embodiments, the memory management and the cycle count for the 4K mode operation is as follows. See FIGS. 9 and 10.

Incoming samples will be first put in R5 for all the PPC symbols. The first step during the PPC processing is to move the samples from R5 to R0. This operation takes 512 cycles.

First stage of 4K FFT will be done in place (R0 and R1 respectively depending on the symbol index). This operation takes 1280 cycles.

Energy computation for interlaces 1 and 5 takes 2*512=1024 cycles. In some implementations, no separate memory is required here.

WID determination from interlace 1 performs one in-place 512-pt FFT (using R0) and then pipelines pilot descrambling, 512-pt IFFT and thresholding/energy computation operation. The memories used for this process are shown in FIG. 9. With the use of two extra memories in R3 and R4, the total number of cycles is 512 (first FFT)+(512+15*512+512)=18*512 cycles=9216 cycles.

LID determination from interlace 0 is similar to step 4 above. Memory management can also be similar to WID determination discussed above. Total cycles required=9216 cycles.

Next computation is 512-pt FFT on interlaces 0, 2, 4 and 6. This will be followed by 4 pilot descrambling operations. FFT and pilot descrambling are pipelined using R1, R2 and R3. At the end of pilot descrambling, the 2K frequency domain samples are in R3. 2K IFFT is done in place to obtain time domain samples. The memory management diagram for this operation is given in FIG. 10. The number of computations for FFTs and pilot descrambling (PD) here is (512+3*512+512) (for FFT+PD)+2700 (2K IFFT)=5260 cycles.

The next step is a data FFT on interlace 3. This will ensure that R0 is available for succeeding operations. 512-pt data FFT is done out of place and puts samples in R1 to be read by the LLR block. Number of cycles required=512 cycles.

Now R0 is free to be used for the 4K channel estimation FFT. IFFT samples from R3 are thresholded and transferred to R0 for 4K FFT. Unthresholded samples in R3 are eventually read by QDSP. Number of cycles used for thresholding and data transfer to R0 is as follows. For each row, there are 1 read+9 cycles (energy computation for 8 samples)+1 write=11 cycles. For 256 rows, there are 11*256=2816 cycles.

For channel estimation, the last 2K samples in R0 need to be filled with zeros. This will take 256 cycles.

First stage of 4K FFT is done in place in R0 (1280 cycles). Then 512-pt FFT is done for interlace 3 (512 cycles) in place. Number of cycles for channel estimation for interlace 1=1280+512=1792 cycles.

Finally, LLR block reads channel estimates from R0 and data samples from R1 and generates 1000-bit LLRs for QPSK symbols. This step takes 512 cycles.

Total number of cycles required for 4K PPC operation is therefore 32396 cycles. Note that the total number of cycles available during PPC symbol processing in 4K mode with 6161 chips is 49288 cycles. Therefore, there is ample room to finish all the PPC processing.

LLR Processing in QDSP

As previously indicated, the transmitter ID slot (slot 3) can consist of 1000 coded bits that are used to convey 56-bits of information including information about the packet type (4-bits), transmitter ID (18-bits), transmitter parameter (such as latitude, longitude, altitude, timing offset) (24-bits), signaling bits (3-bits) and CRC field (7-bits). At the transmitter, the 56 information bits can be first interleaved using a row-column interleaver of dimensions 8×7. The transmitter can write the 56-bits along the rows and can read along the columns. The data can be read out and taken in groups of 7-bits each for encoding using a (62,7) Reed-Muller (RM) code. The coding operation can generate eight codeblocks of (62,7) Reed Muller code resulting in 496 coded bits (8 codeblocks of 62-bits each. The (62,7) Reed Muller code can be derived from the first order (64,7) RM code. The last two-bits of the (64,7) code can be punctured (dropped at the transmitter) to result in the (62,7) code. The 496 coded bits are repeated once to result in 992-bits. Finally, 8-bits of padding (all zeros) are added to generate 1000-bit payload. The 1000-bits are interleaved and mapped to 500 QPSK symbols that are transmitted on interlace 3 of one or more PPC symbols (depending on the FFT mode).

At the receiver, the hardware (described in detail above) can process samples from slot 3 to first generate the LLRs (soft decisions) for the 1000-bits transmitted on slot 3. The convention used for the LLRs in the hardware can be that positive numbers for an LLR represent bit 0 while the negative numbers represent bit 1. The HW also takes care of de-interleaving the 1000-bits at the time of generating LLRs. Repetition by a factor of two at the transmitter can be taken care of at the receiver by combining the LLRs that correspond to the repetitions of a bit. The combination of the bits can be achieved by summing up the corresponding two LLRs and dividing the result by 2. The averaging process yields 496 LLRs, where each LLR can correspond to a bit within one of the aforementioned eight Reed Muller codeblocks produced at the transmit end.

Further, in order to minimize the time taken by the QDSP to read the LLRs, the HW can pack multiple LLRs into one word (32-bits). In particular, each LLR can be represented by 7-bits (signed) in the HW. Therefore, 4 LLRs can be packed in the HW to result in 28-bits that can be accommodated in one word of memory whose width is 32-bits. With a compression ratio of four obtained via packing, the 496 LLRs can be packed in 124 words. The QDSP can use an interface which can read a 32-bit word store it in memory (e.g., a 32-bit wide memory). In some embodiments, the order of packing is as follows. The LLR with the lower index occupies the LSBs of the 32-bit word while the LLR with the higher index occupies the MSBs. Therefore, the kth 32-bit word is arranged as follows, where 4k, 4k+1, etc., are the indices of the LLRs in the kth word:

b6:b0—LLR(4k)

b13:b7—LLR(4k+1)

b20:b14—LLR(4k+2)

b27:b21—LLR(4k+3)

b31:b28—unused

The QDSP processing tasks for slot 3 can be summarized as follows:

Read from the HW the 124 32-bit words containing the 496 LLRs;

Unpack the 32-bit words to extract the individual LLRs;

Collect each block of 62-bits and perform (62,7) RM decoding to result in the underlying 7 information bits;

Collect 56 information bits obtained from decoding and perform row-column de-interleaving (using an 8×7 block);

Perform CRC verification for the 7-bit CRC;

Report packet type (4-bits), transmitter ID (18-bits), transmitter parameter (24-bits), signaling bits (3) and the CRC pass/fail (1-bit) to a controlling data processor.

These tasks are described in more detail below according to exemplary embodiments of the present work.

As mentioned above, four LLRs can be packed into one 32-bit word to be read by the QDSP. In some embodiments, the QDSP uses 5 QDSP cycles to read a 32-bit word. The total time required to read all 124 words can take up to 620 cycles. Further processing of the LLRs in the QDSP can require unpacking the 32-bit words to extract the individual LLRs. Some embodiments combine the reading and unpacking operations.

With the LLRs unpacked, the next step can include Reed Muller decoding, performed on 62 LLRs at a time. The first RM codeblock can correspond to the LLRs 0-61, the second RM codeblock spans LLRs 62-123, the third RM codeblock spans LLRs 124-185, the fourth RM codeblock spans LLRs 186-247, and so on, through the eighth RM codeblock, which spans LLRs 434-495. Let the LLRs be denoted as l₀, l₁, l₂, . . . l₄₉₅. Let Lᵢ denote the set of LLRs corresponding to the i th Reed Muller codeblock. For instance, L₁ contains l₆₂, l₆₃, l₆₄, . . . l₁₂₃.

The (62,7) Reed Muller code used for encoding at the transmitter can be derived from the first order (64,7) Reed Muller code after puncturing the last two-bits from the output codeword. Therefore, the transmitter sends only the first 62-bits out of the total 64-bits comprising each codeword. At the receiver, the decoder replaces the last two LLRs with zeros. Due to the strength of the code, the two missing coded bits should not cause significant performance degradation. Consider now the decoding of each Reed Muller codeblock. Let L denote the 62 LLRs received from the HW for a particular codeblock. After appending two zeros, let X=[x₆₃, x₆₂, x₆₁, . . . x₁, x₀] correspond to the codeword. For instance for the first codeblock, x₀, x₁, . . . , x₆₁ correspond to L₀ while x₆₂ and x₆₃ are the two zeros filled in to make up for the missing bits of the codeword. The decoding task at the receiver is to determine the 7-bits b=[b₆, b₅, . . . b₀] that correspond to the maximum likelihood estimate for the 7 information bits that were used to generate the codeword X.

The first step in the decoding is to perform a 64 dimensional Hadamard transform on the codeword. The result of the Hadamard transform on the 64×1 vector X, denoted by F (also a 64×1 vector) is given by:

F=H₆₄×X,

where H₆₄ is the 64×64 Hadamard matrix. Hadamard matrices satisfy the following property for any integer n:

$${H}_{{2}^{n}} = [ \begin{matrix}{H}_{{2}^{n - 1}} & {H}_{{2}^{n - 1}} \\ {H}_{{2}^{n - 1}} & - {H}_{{2}^{n - 1}}\end{matrix} ] , \\ and$$

$${H}_{1} = [ 1 ] .$$

For example, using the above property, it is easily seen that

$${H}_{2} = [ \begin{matrix}1 & 1 \\ 1 & - 1\end{matrix} ]$$

and so on.

The resulting 64×1 vector F can be used to obtain the 6 most significant underlying information bits b₆, b₅, . . . b₁. In particular, the task at the receiver after performing the Hadamard transform can determine the entry in F with the maximum absolute value. For instance let Fᵢ, the i th entry of F be such that |Fᵢ|≧|Fⱼ| for all j. Then, the binary representation of i gives the bits b₆, b₅, . . . b₁ in that order. For example, let i=49. The binary representation of i corresponds to (110001). Therefore, b₆=1, b₅=1, b₄=0, b₃=0, b₂=0 and b₁=1. The sign of Fᵢ determines the LSB b₀. If Fᵢ≧0, then b₀=0 else b₀=1. (This follows from the notation that LLRs are positive when the bit is 0 and negative when the bit is 1.) The remaining seven Reed Muller codeblocks are decoded in a similar fashion.

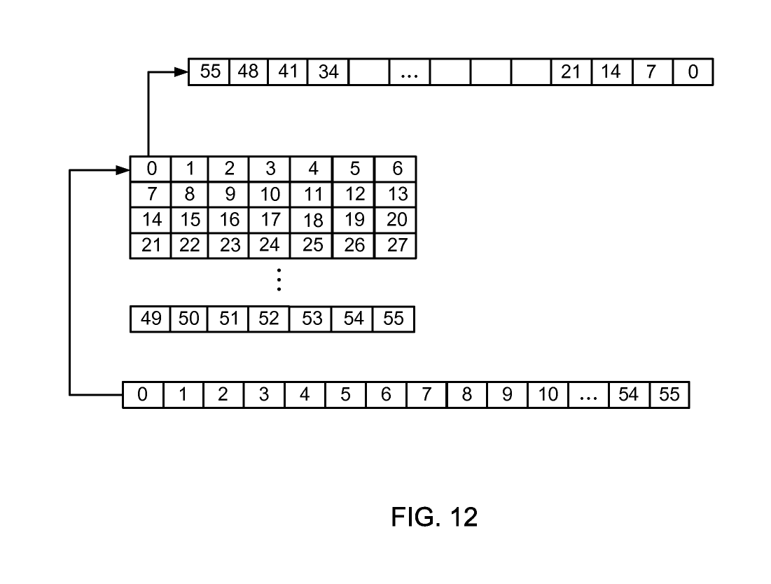

The decoding of the eight Reed Muller codeblocks can produce an interleaved arrangement of the 56 information bits, including bits for the packet type, the transmitter ID, the transmitter parameter and the CRC. Let c₀ through c₅₅ correspond to the 56-bits obtained from decoding the four Reed Muller codeblocks. Note that c₀ through c₆ can correspond to the decoded bits from the first codeblock (with c₀=b₀, c₁=b₁ and so on). Similarly, c₇ through c₁₃ can correspond to the second codeblock and so on. The bits can be de-interleaved by using a row-column de-interleaver. The 56-bits can be written along the rows of an 8×7 matrix. The de-interleaved bits d₀ through d₅₅ can be obtained by reading out along the columns of the matrix. An example of such a de-interleaver is shown in FIG. 12. Note that MSBs are written first and also read first out of the table. For instance, after de-interleaving, (0, 7, 14, 21, 28, 35) will be the 6 MSBs of the decoded PPC packet.

The final step for processing the transmitter ID interlace is to perform CRC verification. The last 7-bits out of the 56-bits d₆ through d₀ can correspond to the CRC bits added by the transmitter. The 7-bit CRC can be generated using the polynomial g(x)=x⁷+x⁶+x⁴+1. The CRC verification process can proceed as follows: the 56 message bits (d₅₅ through d₀) can be treated as the coefficients of a degree-55 polynomial m(x); if m(x) upon division by g(x) leaves a remainder of zero, then the CRC matches (e.g., sets CRC flag to 1); and the decoded codeword can be declared error-free. Otherwise, CRC check fails.

Some embodiments use the following procedure for the CRC check.

(1) Copy 8 MSBs of the information bits (d₅₅ through d₄₈) in that order into DATA register.

(2) Set CRC=11010001. If the leading bit (MSB) of DATA register is 1, add CRC to DATA bitwise modulo 2. This operation can be accomplished by performing bitwise XOR operation on the contents of DATA with the contents of CRC. Denote the resulting 8-bits by REM. If the leading bit (MSB) of DATA is 0, REM is same as DATA. Finally copy REM back to DATA.

(3) Drop the MSB of DATA register, shift the contents of the register to the left by one, and copy next leading MSB from the information bits into the DATA LSB location. For instance, if the DATA register was processing the bits (d₅₅ through d₄₈) in the previous step, then d₄₇ is shifted in the next step while dropping the MSB (last occupied by d₅₅).

(4) Repeat steps 2 and 3 until all the bits in information bit sequence are processed (i.e., d₀ gets loaded into DATA).

(5) At the end of step 4, if the REM is all zeros then the CRC passes. Set CRC_CHECK flag to 1. If REM is non-zero, then CRC fails and set the CRC_CHECK flag to 0.

At the end of CRC verification, QDSP parses the decoded packet and stores the leading fields corresponding to PACKET_TYPE, TRANSMITTER_ID, TRANSMITTER_PARAMETER, TRANSMITTER_ALLOCATION and finally a CRC_CHECK bit. Note that this information will be generated and stored for each of the 8 PPC symbols processed. The information is finally made available to the controlling data processor by the QDSP.

Some embodiments compute the SNR of the signal from a particular transmitter. This is done by computing the signal energy from the time domain channel estimate and adding up the energy above the threshold. Note that this thresholded channel estimate is used as the starting point for computing the frequency domain channel estimate. The noise variance estimate is computed from the unused interlace 5 as already described in the text.

Some embodiments compute the received signal strength from a particular transmitter. This is done by computing the total signal energy received (sum of energy in all the interlaces including interlace 7 where the inactive transmitter are transmitting). The desired signal energy is computed using the thresholded time domain channel estimate as above. Using these two observations, the desired transmitter power can be computed in dBm.

Some embodiments use the time domain channel estimate from a particular transmitter to compute the propagation delay from that transmitter. An example algorithm would be to find the first channel energy tap with non-zero energy in the thresholded time domain channel estimate.

Some embodiments use the propagation delay computed from each of the transmitters to arrive at the geographical location of the device (latitude, longitude and altitude) using well known triangulation techniques.

Some embodiments use the thresholded time domain channel estimate to compute the delay spread of the channel observed from a specific transmitter which is an important metric in many network deployments.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present work.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other non-transitory form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use products that embody principles of the present work. Various modifications to these embodiments will be readily apparent to those skilled in the art, and the generic principles defined herein may be applied to other embodiments without departing from the spirit or scope of the disclosure. Thus, the present work is not intended to be limited to the embodiments shown herein but is to be accorded the widest scope consistent with the principles and novel features disclosed herein.

What is claimed is:

1. A computer-implemented method of extracting transmitter identification information from a Positioning Pilot Channel (PPC) of a Media Forward Link Only superframe, comprising:
determining one of a wide area differentiator (WID) value and a local area differentiator (LID) value associated with the transmitter based on signaling in a first interlace of a symbol received via said PPC;
computing a time domain channel estimate for said PPC based on signaling in a plurality of interlaces of said symbol and also based on said one of said WID value and said LID value;
using said time domain channel estimate to obtain a frequency domain channel estimate for a second interlace of said symbol that carries said transmitter identification information; and
using said frequency domain channel estimate to determine said transmitter identification information.

2. The computer-implemented method of claim 1, wherein said determining includes using each of a plurality of possible values of said one of said WID value and said LID value to descramble frequency domain samples obtained from said first interlace and thereby produce a plurality of descrambled results.

3. The computer-implemented method of claim 2, wherein said determining includes producing a plurality of time domain channel estimates based respectively on said descrambled results.

4. The computer-implemented method of claim 3, wherein said determining includes computing respective corresponding energy measures for said time domain channel estimates, and determining said one of said WID value and said LID value based on said energy measures.

5. The computer-implemented method of claim 4, wherein said computing said energy measures includes applying an energy threshold to tap energies of each said time domain channel estimates.

6. The computer-implemented method of claim 5, wherein said determining includes producing said energy threshold based on a further energy measure associated with said first interlace.

7. The computer-implemented method of claim 1, wherein said computing includes using said one of said WID value and said LID value to descramble frequency domain samples obtained from said plurality of interlaces.

8. The computer-implemented method of claim 1, wherein said determining includes determining the other of said WID value and said LID value based on signaling associated with a third interlace of said symbol and also based on said one of said WID value and said LID value, and wherein said computing includes computing said time domain channel estimate based on the other of said WID value and said LID value.

9. The computer-implemented method of claim 1, wherein said plurality of interlaces is a subset of a total amount of interlaces of said symbol, and wherein said using said time domain channel estimate includes:
zero-padding said time domain channel estimate to produce a zero-padded time domain channel estimate;
applying first stage Fast Fourier Transform (FFT) processing to said zero-padded time domain channel estimate to produce time domain samples associated with said symbol; and
obtaining said frequency domain channel estimate from a subset of said time domain samples associated with said second interlace.

10. An apparatus for extracting transmitter identification information from a Positioning Pilot Channel (PPC) of a Media Forward Link Only superframe, comprising:
a determiner for determining one of a wide area differentiator (WID) value and a local area differentiator (LID) value associated with the transmitter based on signaling in a first interlace of a symbol received via said PPC;
a time domain unit coupled to said determiner and configured for computing a time domain channel estimate for said PPC based on signaling in a plurality of interlaces of said symbol and also based on said one of said WID value and said LID value;
a frequency domain unit coupled to said time domain unit and configured for using said time domain channel estimate to obtain a frequency domain channel estimate for a second interlace of said symbol that carries said transmitter identification information; and
a transmitter identification unit coupled to said frequency domain unit and configured for using said frequency domain channel estimate to determine said transmitter identification information.

11. The apparatus of claim 10, wherein said determiner is configured for obtaining frequency domain samples for said first interlace, and for using each of a plurality of possible values of said one of said WID value and said LID value to descramble said frequency domain samples and thereby produce a plurality of descrambled results.

12. The apparatus of claim 11, wherein said determiner is configured for producing a plurality of time domain channel estimates based respectively on said descrambled results.

13. The apparatus of claim 12, wherein said determiner is configured for computing respective corresponding energy measures for said time domain channel estimates, and determining said one of said WID value and said LID value based on said energy measures.

14. The apparatus of claim 13, wherein said determiner is configured to compute said energy measures by determining tap energies for each of said time domain channel estimates, and applying an energy threshold to said tap energies of each said time domain channel estimates.

15. The apparatus of claim 14, wherein said determiner is configured to produce said energy threshold based on a further energy measure associated with said first interlace.

16. The apparatus of claim 10, wherein said time domain unit is configured to obtain frequency domain samples from said plurality of interlaces, and to use said one of said WID value and said LID value to descramble said frequency domain samples.

17. The apparatus of claim 10, wherein said determiner is configured to determine the other of said WID value and said LID value based on signaling associated with a third interlace of said symbol and also based on said one of said WID value and said LID value, and wherein said time domain unit is configured to compute said time domain channel estimate based on the other of said WID value and said LID value.

18. The apparatus of claim 10, wherein said plurality of interlaces is a subset of a total amount of interlaces of said symbol, and wherein said frequency domain unit is configured:
for zero-padding said time domain channel estimate to produce a zero-padded time domain channel estimate;
for applying first stage Fast Fourier Transform (FFT) processing to said zero-padded time domain channel estimate to produce time domain samples associated with said symbol; and
for obtaining said frequency domain channel estimate from a subset of said time domain samples associated with said second interlace.

19. An apparatus for extracting transmitter identification information from a Positioning Pilot Channel (PPC) of a Media Forward Link Only superframe, comprising:
means for determining one of a wide area differentiator (WID) value and a local area differentiator (LID) value associated with the transmitter based on signaling in a first interlace of a symbol received via said PPC;
means for computing a time domain channel estimate for said PPC based on signaling in a plurality of interlaces of said symbol and also based on said one of said WID value and said LID value;
means for using said time domain channel estimate to obtain a frequency domain channel estimate for a second interlace of said symbol that carries said transmitter identification information; and
means for using said frequency domain channel estimate to determine said transmitter identification information.

20. The apparatus of claim 19, wherein said means for determining includes using each of a plurality of possible values of said one of said WID value and said LID value to descramble frequency domain samples obtained from said first interlace and thereby produce a plurality of descrambled results.

21. The apparatus of claim 20, wherein said means for determining includes producing a plurality of time domain channel estimates based respectively on said descrambled results.

22. The apparatus of claim 21, wherein said means for determining includes means for computing respective corresponding energy measures for said time domain channel estimates, and determining said one of said WID value and said LID value based on said energy measures.

23. The apparatus of claim 22, wherein said means for computing said energy measures includes applying an energy threshold to tap energies of each said time domain channel estimates.

24. The apparatus of claim 23, wherein said means for determining includes producing said energy threshold based on a further energy measure associated with said first interlace.

25. The apparatus of claim 19, wherein said means for computing includes using said one of said WID value and said LID value to descramble frequency domain samples obtained from said plurality of interlaces.

26. The apparatus of claim 19, wherein said means for determining includes determining the other of said WID value and said LID value based on signaling associated with a third interlace of said symbol and also based on said one of said WID value and said LID value, and wherein said means for computing includes computing said time domain channel estimate based on the other of said WID value and said LID value.

27. The apparatus of claim 19, wherein said plurality of interlaces is a subset of a total amount of interlaces of said symbol, and wherein said means for using said time domain channel estimate includes:
means for zero-padding said time domain channel estimate to produce a zero-padded time domain channel estimate;
means for applying first stage Fast Fourier Transform (FFT) processing to said zero-padded time domain channel estimate to produce time domain samples associated with said symbol; and
means for obtaining said frequency domain channel estimate from a subset of said time domain samples associated with said second interlace.

28. A computer readable storage medium encoded with a computer program, the program comprising instructions that when executed by data processing apparatus cause the data processing apparatus to perform operations comprising:
determining one of a wide area differentiator (WID) value and a local area differentiator (LID) value associated with the transmitter based on signaling in a first interlace of a symbol received via said PPC;
computing a time domain channel estimate for said PPC based on signaling in a plurality of interlaces of said symbol and also based on said one of said WID value and said LID value;
using said time domain channel estimate to obtain a frequency domain channel estimate for a second interlace of said symbol that carries said transmitter identification information; and
using said frequency domain channel estimate to determine said transmitter identification information.

29. The computer readable storage medium of claim 28, wherein said determining includes using each of a plurality of possible values of said one of said WID value and said LID value to descramble frequency domain samples obtained from said first interlace and thereby produce a plurality of descrambled results.

30. The computer readable storage medium of claim 29, wherein said determining includes producing a plurality of time domain channel estimates based respectively on said descrambled results.

31. The computer readable storage medium of claim 30, wherein said determining includes computing respective corresponding energy measures for said time domain channel estimates, and determining said one of said WID value and said LID value based on said energy measures.

32. The computer readable storage medium of claim 31, wherein said computing said energy measures includes applying an energy threshold to tap energies of each said time domain channel estimates.

33. The computer readable storage medium of claim 32, wherein said determining includes producing said energy threshold based on a further energy measure associated with said first interlace.

34. The computer readable storage medium of claim 28, wherein said computing includes using said one of said WID value and said LID value to descramble frequency domain samples obtained from said plurality of interlaces.

35. The computer readable storage medium of claim 28, wherein said determining includes determining the other of said WID value and said LID value based on signaling associated with a third interlace of said symbol and also based on said one of said WID value and said LID value, and wherein said computing includes computing said time domain channel estimate based on the other of said WID value and said LID value.

36. The computer readable storage medium of claim 28, wherein said plurality of interlaces is a subset of a total amount of interlaces of said symbol, and wherein said using said time domain channel estimate includes:
zero-padding said time domain channel estimate to produce a zero-padded time domain channel estimate;
applying first stage Fast Fourier Transform (FFT) processing to said zero-padded time domain channel estimate to produce time domain samples associated with said symbol; and
obtaining said frequency domain channel estimate from a subset of said time domain samples associated with said second interlace.
